(19) United States
(12) Patent Application Publication
(10) Pub. No.: US 2008/0257892 A1
(43) Pub. Date: Oct. 23, 2008

(54) Pot for Drinks

(76) Inventor: Sandra Schroter, Krefeld (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/092,631

(22) PCT Filed: Oct. 27, 2006
(86) PCT No.: PCT/DE06/01897

§ 371 Date: May 5, 2008

(30) Foreign Application Priority Data
Nov. 3, 2005 (DE) 20 2005 017 356.8

(51) Int. Cl. A47J 41/00; B65D 25/04

(52) U.S. Cl. 220/524; 220/592.18

(57) ABSTRACT

Pot for drinks having a plurality of chambers, at least one lid element, at least one handle element and at least two closure elements, wherein the closure elements, in a first position, close a respective chamber and, in a second position, release the same, and wherein the closure elements are arranged such that both the use of the same and the act of holding the pot allow the contents to be selectively poured out single-handedly.

The invention relates to a closable pot for pouring out drinks, said pot having a plurality of chambers for keeping drinks.

DE 197 51 358 A1 discloses pots having a plurality of chambers. Described therein is a pot which has a multiplicity of chambers which are closed with individual sealing lids. In order to open a desired chamber, the respective sealing lid has to be removed. This operation is laborious and time-consuming and requires certain dexterity. In particular in the service sector of transport companies, for example in aircraft during the occurrence of turbulence, it turns out to be difficult in the case of a pot as described in DE 197 51 358 A1 to specifically pour a drink from a certain chamber. There is the risk of spilling the drink and of causing scalding in the case of a hot drink.

The object of the invention is to design a pot having the features of the preamble of claim 1 in such a way as to ensure, from a pot having a plurality of chambers, the reliable holding of the pot and at the same time the specific pouring with the use of one hand and without grasping it. This object is achieved by the characterizing features of claim 1; advantageous developments follow from subclaims 2-17.

The essence of the invention is considered to be the arrangement of the closure elements in such a way that both their operation and the holding of the pot enable the contents to be poured out selectively by one-hand operation. This one-hand operation enables the drinks to be poured out more quickly and more safely.

It has proved to be especially advantageous in connection with the invention to mount the closure elements in such a way that they can be shifted into a pouring or closed position by means of a hinged, pivoting or sliding mechanism. Due to such a mounting of the closure elements, “one-hand operation”, that is to say the moving of the closure element of a chamber into the open or closed position while simultaneously holding the pot and the movable fixing of the closure element to the pot, can be realized. This has the advantage that a closure element cannot fall to the floor or be lost. This is ensured by a sliding mechanism in the form of an extension of the closure element, which is mounted on the lid element in a displaceable manner.

In order to design the one-hand operation to be as user-friendly as possible, the operating surfaces of the closure elements extend right into the handle region. The handle region is regarded as the region which can be reached by the fingers of a hand and which one has while simultaneously holding the pot at the handle element with the same hand. The operating surface of the closure element serves as an application point for the fingers in order to shift the closure element into the open or closed position. Therefore the user, who holds the pot with one hand at the handle element, can operate the desired closure element preferably with the thumb of the same hand via, for example, a sliding mechanism.

For subclaims in a development of the invention, it appears to be advantageous if the pot and/or at least one closure element is designed to be heat-insulating or to be heat-insulating in certain regions. By means of the insulation, hot drinks can be kept hot for a longer period and cold drinks can also be kept cold for a longer period. In addition, if the dividing walls of the chamber are insulated, the pot can be filled with drinks at a different temperature. For example, keeping coffee and milk in one pot; in this way, a coffee can now be blended with milk very quickly.

The pot and/or the closure elements can advantageously have a seal. It serves to prevent the drink liquids from running out if the pot is shaken. In addition, seals improve the heat-insulating properties of the pot at its opening.

An energy storage mechanism on the closure element, which energy storage mechanism is arranged in such a way that it preloads the closure element in the closed position, can prove to be very expedient. The ease of operation is further increased by the energy storage mechanism, which, e.g. in the form of an elastic medium, may comprise both a steel spring and a soft rubber. By means of the preloading of the closure element in the closed position, an actuation now only has to take place during the pouring; the closure element moves into the closed position after the pouring. Consequently, the operator does not have to move back the closure element.

In addition, the provision of a locking device for preventing simultaneous opening of a plurality of closure elements has proved to be especially advantageous. Since usually only one drink is desired and many mixed drinks are offered as made-up drinks by the manufacturers and a mixed drink rarely has to be mixed on the spot, it is expedient to prevent the simultaneous and unintentional pouring-out from a plurality of chambers via a locking device. In the case of a mixed drink, too, such as coffee with milk, it is advantageous to pour out the two liquids one after the other, since the simultaneous dispensing of the two liquids could be too much for the user.

In order to allow the pouring operation to take place in a controlled manner, it is advantageous to provide at least one pouring spout on the pot. Such pouring spouts serve to make it easier to pour out the chamber contents into a further container, since they ensure, due to their geometrical form, the reliable pouring even during low mass flows. It is also conceivable to provide a respective pouring spout for each chamber of the pot.

If at least two chambers extend right into the pouring spout, the problem of possible undesirable mixing of drinks in the region of the pouring spouts in the case of a pot having a smaller number of pouring spouts than chambers can be avoided. Owing to the fact that the pouring spout is subdivided, the drink to be poured out cannot intermix with residues of the drink of another chamber poured out last, said residues remaining in the form of droplets in the pouring spout.

Interchangeability of the individual chambers of the pot proves to be especially advantageous. If, for example, one chamber is emptied, it can be interchanged with a filled chamber without the entire pot having to be transported to the filling location. Also, when the pot is filled with heated drinks, said drinks, if they no longer have the desired temperature, can be separated in their chamber from the pot and can be heated to the desired temperature together with the chamber, for example in a microwave or in other heaters, and can then be connected again to the remaining chambers of the pot.

The releasing or the connecting of the chambers is advantageously ensured via a mechanism which is preferably arranged in the base of the pot. However, the mechanism for releasing or connecting the chambers may also be located in the handle region; comfortable one-hand operation would thereby be possible. The mechanism for releasing and connecting the chambers can preferably be designed as a rotary mechanism; this allows cost-effective, mechanical and reliable handling. In principle, however, this mechanism could also be realized by a magnetic connection or a snap latching connection.

A further advantage is obtained from the fact that the plurality of chambers is releasably connected to at least one of the closure elements and/or at least one of the lid elements. By the temporary removal of the closure and/or lid element, both quicker filling and a larger clearance space for the cleaning of the pot are provided through the now larger chamber opening. In this connection, it appears to be advantageous to arrange at least one closure element on at least one lid element. This enables the chamber opening to be opened more quickly, since the lid element and the closure element now do not have to be removed individually.

With the arrangement of a plurality of mutually releasable chambers in a common housing, a more stable and visually more attractive pot which is also more favorable in terms of production costs can be created. The separation of the stability and the drink-holding function, which the pot has to fulfill, grants more design latitude for the individual components (outer housing and drink-holding chambers). Thus a variant could provide, for example, a flexible drinks container in the form of a cost-effective plastic bag and a stainless steel device for the outer housing.

In order to permit quicker pouring, it is expedient to design at least one closure element to be latchable in the pouring position. In this way, the closure element does not have to be held manually in the open position during the entire pouring operation. In particular when using an energy storage mechanism for preloading the closure element in the closed position, an increase in comfort is achieved by means of the latching of the closure element. Furthermore, it is advantageous if at least one closure element can be latched in the pouring position with different pouring cross sections. In this case, a first, smaller cross section could permit slow pouring aimed at precise dispensing and a second, larger cross section could permit quicker pouring.

The invention is explained in more detail with reference to exemplary embodiments in the figures of the drawing, in which:

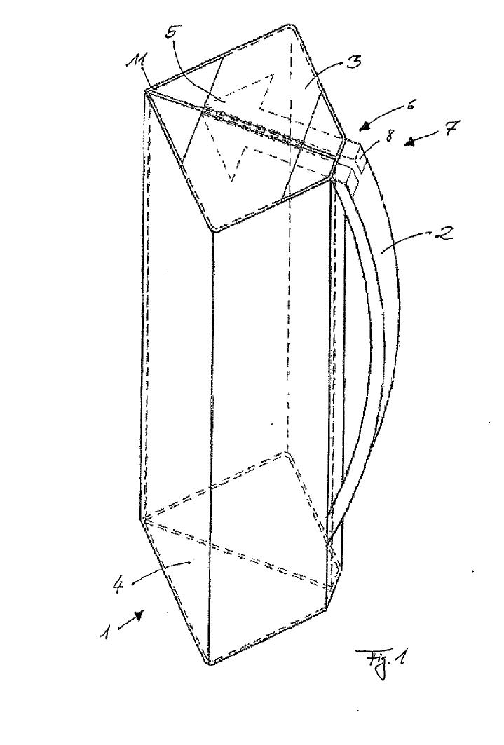

FIG. 1 shows a perspective illustration of the pot having two chambers, a handle and displaceable closure elements;

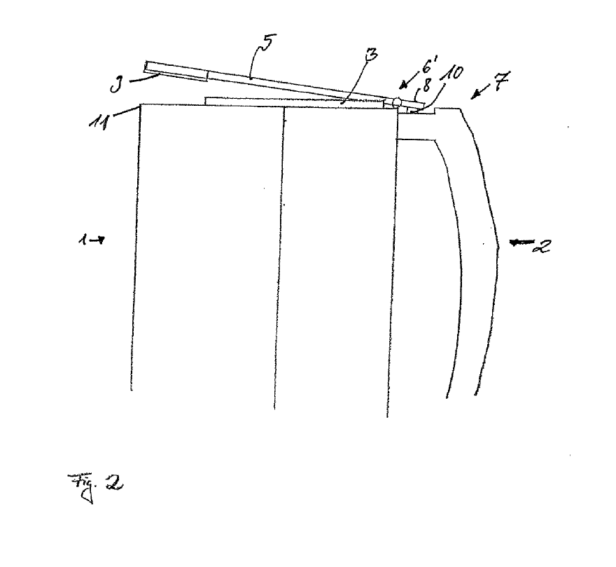

FIG. 2 shows an illustration of a chamber having a hinge mechanism for the closure element and an energy storage mechanism;

FIG. 3 shows a plan view of a pot, the chambers being shown in the position released from one another;

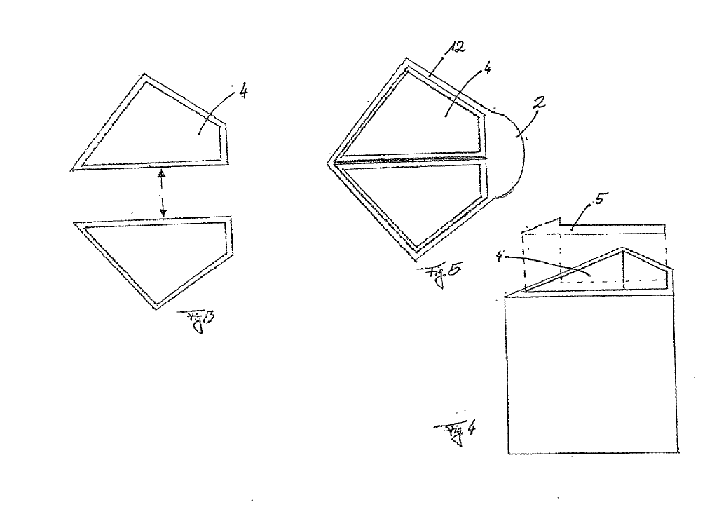

FIG. 4 shows an individual chamber of a pot, the closure element being shown in a position released from the pot;

FIG. 5 shows a plan view of a pot, the arrangement of the chambers being shown in a common housing;

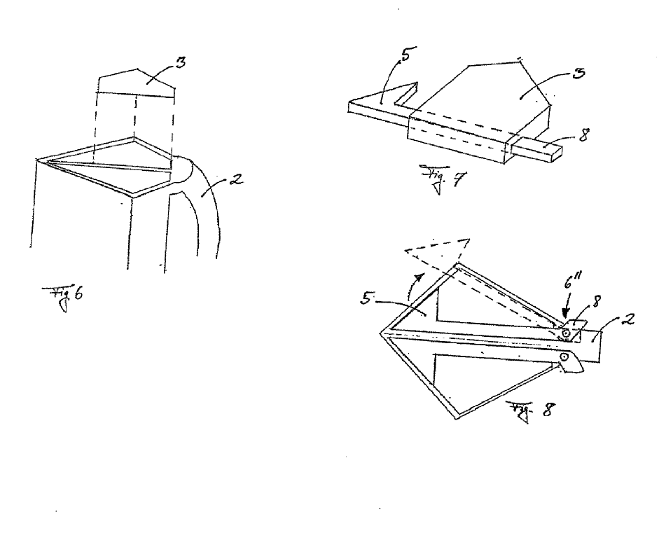

FIG. 6 shows a pot having a lid element in a position released from the pot;

FIG. 7 shows an illustration of a lid element in which the closure element is displaceably mounted;

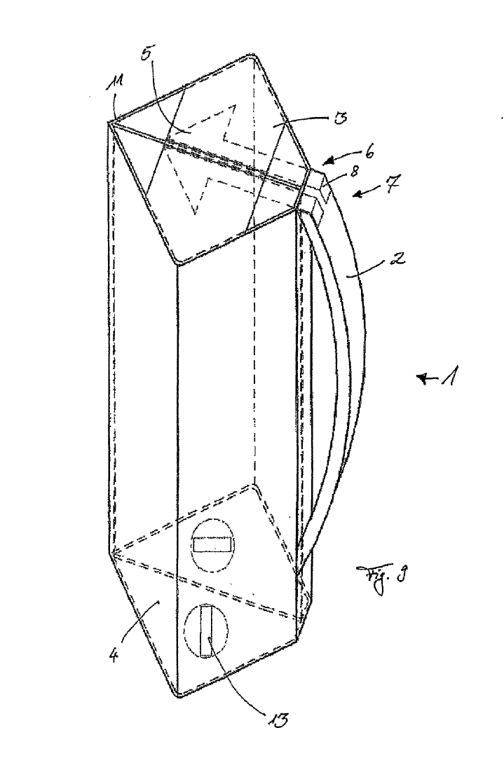

FIG. 8 shows a plan view of a pot, the closure element being arranged on the pot in a pivotable manner;

FIG. 9 shows an illustration according to FIG. 1 having rotary closures in the base region.

The pot 1 for drinks has a plurality of chambers 4 with at least one lid element 3, at least one handle element 2 and at least two closure elements 5, wherein the closure elements 5 close a respective chamber 4 in a first position and open the latter in a second position, and the closure elements 5 are arranged in such a way that both their operation and the holding of the pot 1 enable the contents to be poured out selectively by one-hand operation.

So that the closure element 5 cannot be lost or fall to the floor, it is fastened to the pot 1 by means of a sliding 6, hinged 6′ or pivoting mechanism 6″. The sliding mechanism 6 is shown in FIG. 1, the hinged mechanism 6′ is shown in FIG. 2 and the pivoting mechanism 6″ is shown in FIG. 8.

In order to design the one-hand operation to be as comfortable as possible, it is expedient to arrange the operating surfaces of the closure elements 5 in the handle region 7 (close to the handle 2).

In order to improve the heat-insulating properties, it is advantageous to design the pot 1 and/or the closure element 5 to be entirely heat-insulating or to be heat-insulating in certain regions and to also provide at least one closure element 5 with a seal 9, as shown in FIG. 2. An energy storage mechanism 10 on the closure element 5 can likewise be seen from this drawing, said energy storage mechanism 10 being arranged in such a way that it preloads the closure element 5 in the closed position.

A locking mechanism prevents a plurality of closure elements 5 from opening simultaneously. Unintentional mixing of a plurality of liquids when pouring is therefore ruled out.

The pot 1 has a pouring spout 11 for easier pouring; in particular, it is expedient to extend the chamber separation right into the region of the pouring spout 11. Mixing of the drink to be poured out and possible residues in the pouring spout 11 of the previous drink can thereby be avoided.

As shown in FIG. 3, individual chambers 4 are releasably connected to one another. In order to prevent unintentional release of the chambers 4, it is expedient to provide a mechanism 13 for releasing and connecting the chambers 4, the operating element of which is preferably arranged in the base region of the pot 1.

However, the operating element of the mechanism 13 for releasing and connecting the chambers 4 may also be attached in the handle region 7 of the handle element 2. The mechanism 13 is realized in the form of a rotary mechanism, as can be seen from FIG. 9.

FIGS. 4 and 6 show that the plurality of chambers 4 is releasably connected to the closure element 5 and/or the lid element 3.

Furthermore, it is advantageous to arrange at least one closure element 5 on the lid element 3; this can be seen from FIG. 7, where the closure element 5 is mounted in a lid element 3 in a displaceable manner.

The arrangement of a plurality of chambers 4 in a common outer housing 12 is shown in FIG. 5.

Latching of the closure element 5 in the pouring position simplifies the handling of the pot 1. The ease of operation can again be increased if latching occurs when the closure mechanism 5 is shifted from the open into the closed position, or vice versa. In the case of a smaller latched cross section of the pouring opening, a smaller volumetric flow can be poured out and therefore facilitates more exact dispensing during the pouring.

1. A pot for drinks, comprising
a plurality of chambers,
at least one lid element,
at least one pouring spout,
at least one handle element, and
at least two closure elements, wherein
the closure elements close a respective chamber in a first position and open the latter in a second position, and
the closure elements are arranged in such a way that both their operation and the holding of the pot enable the contents to be poured out selectively by one-hand operation characterized in that each chamber of the pot has a pouring spout assigned to it, or the pouring spout is designed to be separate in such away that the liquids of two chambers are not directed through the same pouring spout section.

2. The pot as claimed in claim 1, characterized in that the closure elements are mounted in such a way that they can be shifted into a pouring or closed position by means of a sliding, hinged or pivoting mechanism.

3. The pot as claimed in claim 1, characterized in that the operating surface of the closure elements is located in the handle region.

4. The pot as claimed in claim 1, characterized in that it and/or at least one closure element is designed to be heat-insulating or to be heat-insulating in certain regions.

5. The pot as claimed in claim 1, characterized in that it and/or at least one closure element has a seal.

6. The pot as claimed in claim 1, characterized in that an energy storage mechanism is arranged on the closure element in such a way that it preloads the closure element in the closed position.

7. The pot as claimed in claim 1, characterized in that a locking device for preventing simultaneous opening of a plurality of closure elements is provided.

8. The pot as claimed in claim 1, characterized in that the individual chambers are releasably connected to one another.

9. The pot as claimed in claim 8, characterized in that the chambers can be released and connected by means of a mechanism which has an operating element in the base region of the pot.

10. The pot as claimed in claim 9, characterized in that the mechanism for releasing and connecting the chambers is designed as a rotary mechanism.

11. The pot as claimed in claim 1, characterized in that the plurality of chambers is releasably connected to the closure element and/or the lid element.

12. The pot as claimed in claim 1, characterized in that at least one closure element is arranged on the lid element.

13. The pot as claimed in claim 1, characterized in that the plurality of chambers is arranged in a common outer housing.

14. The pot as claimed in claim 1, characterized in that at least one closure element can be latched in the pouring position.

15. The pot as claimed in claim 1, characterized in that at least one closure element can be latched in the pouring position with different pouring cross sections.
